(19) United States
(12) Patent Application Publication
(10) Pub. No.: US 2025/0216591 A1
(43) Pub. Date: Jul. 3, 2025

(54) LAMINATE AND OPTICAL ELEMENT-CONTAINING LAMINATE

(71) Applicant: FUJIFILM Corporation, Tokyo (JP)

(72) Inventors: Koji IIJIMA, Minamiashigara-shi (JP); Takashi YONEMOTO, Minamiashigara-shi (JP); Masaaki SUZUKI, Minamiashigara-shi (JP)

(73) Assignee: FUJIFILM Corporation, Tokyo (JP)

(21) Appl. No.: 19/083,569

(22) Filed: Mar. 19, 2025

Related U.S. Application Data
(63) Continuation of application No. PCT/JP2023/035667, filed on Sep. 29, 2023.

(30) Foreign Application Priority Data
Sep. 30, 2022 (JP) 2022-158945

(51) Int. Cl. G02B 5/30

(52) U.S. Cl. CPC G02B 5/3016

(57) ABSTRACT

The present invention provides a laminate in which optical characteristics of an optical element can be accurately inspected even in a case where inspection light is incident from an oblique direction with respect to a bonded body obtained by bonding the optical element; and an optical element-containing laminate. The laminate of the present invention includes a sticky adhesive layer, an optically isotropic layer, and a first peelable protective layer in this order, in which an in-plane retardation Re1(550) of the optically isotropic layer at a wavelength of 550 nm and a thickness direction retardation Rth1(550) of the optically isotropic layer at a wavelength of 550 nm satisfy a predetermined relationship, and an in-plane retardation Re2(550) of the first peelable protective layer at a wavelength of 550 nm and a thickness direction retardation Rth2(550) of the first peelable protective layer at a wavelength of 550 nm satisfy a predetermined relationship.

### CROSS-REFERENCE TO RELATED APPLICATIONS

This application is a Continuation of PCT International Application No. PCT/JP2023/035667 filed on Sep. 29, 2023, which claims priority under 35 U.S.C. § 119(a) to Japanese Patent Application No. 2022-158945 filed on Sep. 30, 2022. The above applications are hereby expressly incorporated by reference, in their entirety, into the present application.

### BACKGROUND OF THE INVENTION

### 1. Field of the Invention

The present invention relates to a laminate and an optical element-containing laminate.

### 2. Description of the Related Art

An optical element represented by a diffraction element, a lens, a prism, and the like are used in various fields.

Examples of the optical element as described above include an optical element including an optically anisotropic layer having a liquid crystal alignment pattern in which an orientation of an optical axis derived from a liquid crystal compound continuously changes rotationally in at least one in-plane direction, as disclosed in JP2022-095795A.

### SUMMARY OF THE INVENTION

Various optical elements such as the optically anisotropic layer disclosed in JP2022-095795A often have insufficient mechanical strength, and there is a problem that the optical element itself is likely to be damaged and handleability is difficult. In such a case, for the purpose of protecting a surface of the optical element and imparting mechanical strength, various members may be bonded to the optical element and handled in a state of the obtained bonded body. As necessary, at least a part of the bonded members may be peeled off.

In addition, in a case of handling the bonded body in the form as described above, it is preferable that optical characteristics of the optical element included in the bonded body can be inspected in the form of the bonded body in order for purchaser or the like who has purchased the bonded body to simply inspect whether or not the bonded body is an optical element satisfying predetermined optical characteristics. In particular, it is desirable that the optical characteristics of the optical element can be inspected even in a case where inspection light is incident from an oblique direction with respect to a normal direction of a surface of the member bonded to the optical element in the bonded body.

As a result of studying characteristics of the member bonded to the optical element, the present inventors have found that, depending on the type of the member, in a case where inspection light is incident from an oblique direction into the obtained bonded body, the optical characteristics of the optical element may not be accurately inspected.

In view of the above circumstances, an object of the present invention is to provide a laminate in which optical characteristics of an optical element can be accurately inspected even in a case where inspection light is incident from an oblique direction with respect to a bonded body obtained by bonding the optical element.

Another object of the present invention is to provide an optical element-containing laminate.

As a result of intensive studies to solve the above-described problems, the present inventors have completed the present invention having the following configurations.

(1) A laminate comprising, in the following order:
a sticky adhesive layer;
an optically isotropic layer; and
a first peelable protective layer,
in which an in-plane retardation Re1(550) of the optically isotropic layer at a wavelength of 550 nm and a thickness direction retardation Rth1(550) of the optically isotropic layer at a wavelength of 550 nm satisfy a relationship of expressions (1A) and (1B) described later, and
an in-plane retardation Re2(550) of the first peelable protective layer at a wavelength of 550 nm and a thickness direction retardation Rth2(550) of the first peelable protective layer at a wavelength of 550 nm satisfy a relationship of expressions (2A) and (2B) described later.

(2) The laminate according to (1),
in which an adhesive strength between the first peelable protective layer and the optically isotropic layer is smaller than an adhesive strength between the optically isotropic layer and the sticky adhesive layer.

(3) The laminate according to (1) or (2),
in which an adhesive strength between the optically isotropic layer and the sticky adhesive layer is 1.0 N/25 mm or more.

(4) The laminate according to any one of (1) to (3),
in which the first peelable protective layer includes a support and a pressure-sensitive adhesive layer,
the pressure-sensitive adhesive layer is disposed on an optically isotropic layer side with respect to the support, and
an in-plane retardation Re3(550) of the support at a wavelength of 550 nm and a thickness direction retardation Rth3(550) of the support at a wavelength of 550 nm satisfy a relationship of expressions (3A) and (3B) described later.

(5) The laminate according to any one of (1) to (4),
in which the optically isotropic layer contains at least one selected from the group consisting of a triacetyl cellulose, an acrylic polymer, a methacrylic polymer, a cycloolefin polymer, and a polycarbonate.

(6) The laminate according to (4) or (5),
in which a thickness of the pressure-sensitive adhesive layer is 5 to 30 μm.

(7) The laminate according to any one of (1) to (6),
in which a thickness of the optically isotropic layer is 5 to 60 μm.

(8) An optical element-containing laminate comprising, in the following order:
the laminate according to any one of (1) to (7);
an optical element; and
a second peelable protective layer,
in which the sticky adhesive layer in the laminate is disposed on an optical element side with respect to the first peelable protective layer, and
an in-plane retardation Re4(550) of the second peelable protective layer at a wavelength of 550 nm and a thickness direction retardation Rth4(550) of the second peelable protective layer at a wavelength of 550 nm satisfy a relationship of expressions (4A) and (4B) described later.

According to the present invention, it is possible to provide a laminate in which optical characteristics of an optical element can be accurately inspected even in a case where inspection light is incident from an oblique direction with respect to a bonded body obtained by bonding the optical element.

In addition, according to the present invention, it is possible to provide an optical element-containing laminate.

### BRIEF DESCRIPTION OF THE DRAWINGS

FIG. 1 is an example of a schematic cross-sectional view of an embodiment of a laminate according to the present invention.

FIG. 2 is an example of a schematic cross-sectional view of an embodiment of an optical element-containing laminate according to the present invention.

FIG. 3 is a view conceptually showing an example of an optically anisotropic layer.

FIG. 4 is a plan view of the optically anisotropic layer shown in FIG. 3.

### DESCRIPTION OF THE PREFERRED EMBODIMENTS

Hereinafter, the present invention will be described in detail.

Any numerical range expressed using “to” in the present specification refers to a range including the numerical values before and after the “to” as a lower limit value and an upper limit value, respectively.

In addition, an in-plane slow axis and an in-plane fast axis are defined at a wavelength of 550 nm unless otherwise specified. That is, unless otherwise specified, for example, an in-plane slow axis direction means a direction of the in-plane slow axis at a wavelength of 550 nm.

In the present invention, Re(λ) and Rth(λ) represent an in-plane retardation at a wavelength λ and a thickness direction retardation at a wavelength λ, respectively. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

Although R0(λ) is displayed as a numerical value calculated by AxoScan, it means Re(λ).

In the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, a term “(meth)acrylic” is used to mean “either one or both of acrylic and methacrylic”.

A feature point of the laminate according to the embodiment of the present invention is that the peelable protective layer and the optically isotropic layer, included in the laminate, exhibit predetermined optical characteristics. The present inventors have found that optical characteristics of an optical element may not be accurately inspected depending on the in-plane retardation and the thickness direction retardation of the member to be bonded to the optical element. Based on these findings, it has been found that a desired effect can be obtained by setting the in-plane retardations and the thickness direction retardations of the peelable protective layer and the optically isotropic layer in the laminate to be bonded to the optical element at a wavelength of 550 nm to predetermined ranges.

### <Laminate>

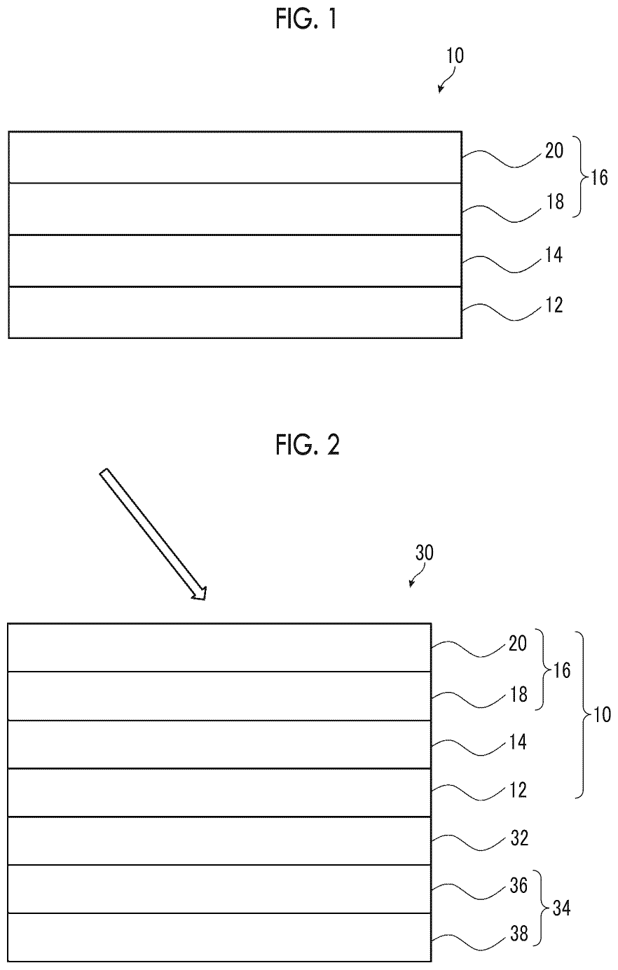

Hereinafter, the embodiment of the laminate according to the present invention will be described with reference to the accompanying drawing. FIG. 1 shows a schematic cross-sectional view of the embodiment of the laminate according to the present invention.

In FIG. 1, a laminate 10 includes a sticky adhesive layer 12, an optically isotropic layer 14, and a first peelable protective layer 16. The first peelable protective layer 16 includes a pressure-sensitive adhesive layer 18 and a support 20. In the first peelable protective layer 16, the pressure-sensitive adhesive layer 18 is disposed on the optically isotropic layer 14 side with respect to the support 20.

As described later, the laminate 10 is bonded to the optical element on the sticky adhesive layer 12 side. Thereafter, the laminate can be handled in a form of a bonded body (for example, an optical element-containing laminate described later) obtained by bonding the laminate 10 to the optical element. In addition, in the present invention, even in a case where inspection light is incident from an oblique direction onto a surface of the laminate side in the form of the obtained bonded body, the optical characteristics of the optical element can be accurately inspected. Furthermore, the first peelable protective layer can be peeled off from the obtained bonded body as necessary.

It is preferable that an adhesive strength between the first peelable protective layer 16 and the optically isotropic layer 14 is smaller than an adhesive strength between the optically isotropic layer 14 and the sticky adhesive layer 12. By satisfying the above-described relationship of the adhesive strength, in a case of peeling off the first peelable protective layer 16, peeling is likely to proceed between the first peelable protective layer 16 and the optically isotropic layer 14, and peeling is unlikely to occur between the optically isotropic layer 14 and the sticky adhesive layer 12.

Hereinafter, each layer will be described in detail.

### (Sticky Adhesive Layer)

The laminate according to the embodiment of the present invention includes a sticky adhesive layer. In a case where the laminate includes the sticky adhesive layer, the laminate can be bonded to an optical element described later.

The sticky adhesive layer is a layer formed of a pressure sensitive adhesive or an adhesive. That is, the sticky adhesive layer may be a pressure-sensitive adhesive layer formed of a pressure sensitive adhesive or may be an adhesive layer formed of an adhesive.

As the pressure sensitive adhesive, a known pressure sensitive adhesive can be used.

Examples of the pressure sensitive adhesive include a (meth)acrylic pressure sensitive adhesive, a silicone-based pressure sensitive adhesive, a rubber-based pressure sensitive adhesive, a urethane-based pressure sensitive adhesive, a polyvinyl alcohol-based pressure sensitive adhesive, a polyvinylpyrrolidone-based pressure sensitive adhesive, a polyacrylamide-based pressure sensitive adhesive, a cellulose-based pressure sensitive adhesive, a vinylalkyl ether-based pressure sensitive adhesive.

As the adhesive, a known adhesive can be used.

Examples of the adhesive include a photocurable adhesive. The photocurable adhesive exhibits a strong adhesion force by being crosslinked and cured by receiving active energy rays such as ultraviolet rays and electron beams, and may contain a polymerizable compound, a photopolymerization initiator, and the like.

It is preferable that the sticky adhesive layer does not have optical anisotropy.

Specifically, an in-plane retardation of the sticky adhesive layer at a wavelength of 550 nm is preferably 5 nm or less and more preferably 0 nm.

In addition, a thickness direction retardation of the sticky adhesive layer at a wavelength of 550 nm is preferably-5 to 5 nm and more preferably 0 nm.

A thickness of the sticky adhesive layer is not particularly limited, and but from the viewpoint of adhesiveness to the optical element and viewpoint of reduction in thickness, it is preferably 5 to 30 μm and more preferably 5 to 15 μm.

The thickness of the sticky adhesive layer is an average value obtained by measuring thicknesses of any 10 points of the sticky adhesive layer using a constant pressure thickness meter PG-18J (manufactured by Tec Lock Co., Ltd.) and arithmetically averaging the measured values.

### (Optically Isotropic Layer)

The laminate according to the embodiment of the present invention includes an optically isotropic layer. The optically isotropic layer functions as a support member which supports the optical element described later. That is, the optically isotropic layer contributes to the improvement of the handleability of the bonded body obtained by bonding the laminate according to the embodiment of the present invention to the optical element.

An in-plane retardation Re1(550) of the optically isotropic layer at a wavelength of 550 nm and a thickness direction retardation Rth1(550) of the optically isotropic layer at a wavelength of 550 nm satisfy a relationship of Expressions (1A) and (1B).

$$0 nm \leq Re 1 ( 550 ) \leq 10 nm \qquad Expression ( 1 A )$$

$$- 10 nm \leq Rth 1 ( 550 ) \leq 10 nm \qquad Expression ( 1 B )$$

Among these, from the viewpoint that the inspection of the optical characteristics of the optical element can be more accurately performed in a case where inspection light is inspection light is incident from an oblique direction with respect to the bonded body obtained by bonding the optical element and the laminate according to the embodiment of the present invention (hereinafter, also simply referred to as “viewpoint that the effect of the present invention is more excellent”), the in-plane retardation Re1(550) of the optically isotropic layer at a wavelength of 550 nm preferably satisfies a relationship of Expression (1A-1).

$$0 nm \leq Re 1 ( 550 ) \leq 3 nm \qquad Expression ( 1 A - 1 )$$

In addition, from the viewpoint that the effect of the present invention is more excellent, the thickness direction retardation Rth1(550) of the optically isotropic layer at a wavelength of 550 nm preferably satisfies a relationship of Expression (1B-1).

$$- 5 nm \leq Rth 1 ( 550 ) \leq 5 nm \qquad Expression ( 1 B - 1 )$$

The type of the material contained in the optically isotropic layer is not particularly limited as long as the optically isotropic layer satisfies the above-described optical characteristics.

Among these, from the viewpoint that the effect of the present invention is more excellent, it is preferable that the optically isotropic layer contains at least one selected from the group consisting of a triacetyl cellulose, an acrylic polymer, a methacrylic polymer, a cycloolefin polymer, and a polycarbonate.

An adhesive strength between the optically isotropic layer and the sticky adhesive layer is not particularly limited, and is often 0.1 N/25 mm or more. In a case where the first peelable protective layer is peeled off after the laminate according to the embodiment of the present invention is bonded to the optical element, from the viewpoint that floating or peeling between the optically isotropic layer and the sticky adhesive layer is unlikely to occur, the above-described adhesive strength is preferably 1.0 N/25 mm or more, and more preferably 1.5 N/25 mm or more. The upper limit of the above-described adhesive strength is not particularly limited, but is often 20 N/25 mm or less and more often 15 N/25 mm or less.

A method of measuring the above-described adhesive strength is as follows.

The sticky adhesive layer side of the laminate of the sticky adhesive layer and the optically isotropic layer (width: 25 mm) is bonded to glass, and the optically isotropic layer is peeled off under the conditions of a peeling rate of 300 mm/min and 90 degree peeling using TENSILON (manufactured by A&D Company, Limited), and a value obtained by arithmetically averaging the strengths at a peeling distance of 10 mm to 50 mm is used as the adhesive strength.

A thickness of the optically isotropic layer is not particularly limited, but from the viewpoint of handleability and reduction in thickness, it is preferably 5 to 60 μm and more preferably 10 to 30 μm.

The thickness of the optically isotropic layer is an average value obtained by measuring thicknesses of any 10 points of the optically isotropic layer using a constant pressure thickness meter PG-18J (manufactured by Tec Lock Co., Ltd.) and arithmetically averaging the measured values.

### (First Peelable Protective Layer)

The laminate according to the embodiment of the present invention includes a first peelable protective layer. The first peelable protective layer can be peeled off after the laminate is bonded to the optical element. For example, the reduction in thickness is achieved by laminating the optical element in the bonded body obtained by bonding the optical element and the laminate with another member and then peeling off the first peelable protective layer.

An in-plane retardation Re2(550) of the first peelable protective layer at a wavelength of 550 nm and a thickness direction retardation Rth2(550) of the first peelable protective layer at a wavelength of 550 nm satisfy a relationship of Expressions (2A) and (2B).

$$0 nm \leq Re 2 ( 550 ) \leq 10 nm \qquad Expression ( 2 A )$$

$$- 10 nm \leq Rth 2 ( 550 ) \leq 10 nm \qquad Expression ( 2 B )$$

Among these, from the viewpoint that the effect of the present invention is more excellent, the in-plane retardation Re2(550) of the first peelable protective layer at a wavelength of 550 nm preferably satisfies a relationship of Expression (2A-1).

$$0 nm \leq Re 2 ( 550 ) \leq 5 nm \qquad Expression ( 2 A - 1 )$$

In addition, from the viewpoint that the effect of the present invention is more excellent, the thickness direction retardation Rth2(550) of the first peelable protective layer at a wavelength of 550 nm preferably satisfies a relationship of Expression (2B-1).

$$- 8 nm \leq Rth 2 ( 550 ) \leq 8 nm \qquad Expression ( 2 B - 1 )$$

The configuration of the first peelable protective layer is not particularly limited as long as it is a member that exhibits the above-described optical characteristics and is peelable from the optically isotropic layer, but it is preferable to include a support and a pressure-sensitive adhesive layer.

The support may be composed of an organic material or an inorganic material. Among these, the support is preferably a resin support.

Examples of a material of the resin support include a cellulose-based polymer, a (meth)acrylic polymer, a polyester-based polymer, a styrene-based polymer, and an olefin-based polymer.

Among these, triacetyl cellulose is preferable as the material of the resin support.

An in-plane retardation Re3(550) of the support at a wavelength of 550 nm and a thickness direction retardation Rth3(550) of the support at a wavelength of 550 nm are not particularly limited, but from the viewpoint that the effect of the present invention is more excellent, it is preferable to satisfy a relationship of Expressions (3A) and (3B).

$$0 nm \leq Re 3 ( 550 ) \leq 10 nm \qquad Expression ( 3 A )$$

$$- 10 nm \leq Rth 3 ( 550 ) \leq 10 nm \qquad Expression ( 3 B )$$

Among these, from the viewpoint that the effect of the present invention is more excellent, the in-plane retardation Re3(550) of the support at a wavelength of 550 nm preferably satisfies a relationship of Expression (3A-1).

$$0 nm \leq Re 3 ( 550 ) \leq 5 nm \qquad Expression ( 3 A - 1 )$$

In addition, from the viewpoint that the effect of the present invention is more excellent, the thickness direction retardation Rth3(550) of the support at a wavelength of 550 nm preferably satisfies a relationship of Expression (3B-1).

$$- 8 nm \leq Rth 3 ( 550 ) \leq 8 nm \qquad Expression ( 3 B - 1 )$$

A thickness of the support is not particularly limited, but from the viewpoint of handleability and reduction in thickness, it is preferably 5 to 200 μm and more preferably 10 to 100 μm.

Examples of a material constituting the pressure-sensitive adhesive layer include the materials exemplified in the sticky adhesive layer described above.

It is preferable that the pressure-sensitive adhesive layer does not have optical anisotropy.

Specifically, an in-plane retardation of the pressure-sensitive adhesive layer at a wavelength of 550 nm is preferably 5 nm or less and more preferably 0 nm.

In addition, a thickness direction retardation of the pressure-sensitive adhesive layer at a wavelength of 550 nm is preferably-5 to 5 nm and more preferably 0 nm.

A thickness of the pressure-sensitive adhesive layer is not particularly limited, and but from the viewpoint of adhesive strength to the optically isotropic layer and viewpoint of reduction in thickness, it is preferably 5 to 30 μm and more preferably 5 to 15 μm.

An adhesive strength between the optically isotropic layer and the first peelable protective layer (the pressure-sensitive adhesive layer in the first peelable protective layer) is not particularly limited, and as described above, in a case where the first peelable protective layer is peeled off after the laminate according to the embodiment of the present invention is bonded to the optical element, from the viewpoint that floating or peeling between the optically isotropic layer and the sticky adhesive layer is unlikely to occur, it is preferable that the adhesive strength between the optically isotropic layer and the first peelable protective layer is smaller than the adhesive strength between the optically isotropic layer and the sticky adhesive layer.

The adhesive strength between the optically isotropic layer and the first peelable protective layer is preferably 1.0 N/25 mm or less, and more preferably 0.5 N/25 mm or less. The lower limit of the adhesive strength is not particularly limited, but is 0.1 N/25 mm or more in many cases.

A method of measuring the above-described adhesive strength is as follows.

The sticky adhesive layer side of the laminate of the sticky adhesive layer, the optically isotropic layer, and the first peelable protective layer (width: 25 mm) is bonded to glass, and only the first peelable protective layer is peeled off under the conditions of a peeling rate of 300 mm/min and 90 degree peeling using TENSILON (manufactured by A&D Company, Limited), and a value obtained by arithmetically averaging the strengths at a peeling distance of 10 mm to 50 mm is used as the adhesive strength.

### <Manufacturing Method of Laminate>

A manufacturing method of the laminate according to the embodiment of the present invention is not particularly limited, and a known method can be adopted.

For example, the laminate can be manufactured by facing one surface of the optically isotropic layer and the pressure-sensitive adhesive layer of the first peelable protective layer including the support and the pressure-sensitive adhesive layer to each other, bonding the optically isotropic layer and the first peelable protective layer to each other, and bonding the other surface of the optically isotropic layer in the obtained bonded body to the sheet of the sticky adhesive layer.

### <Optical Element-Containing Laminate>

The laminate according to the embodiment of the present invention can be bonded to an optical element. As described above, by bonding the laminate according to the embodiment of the present invention to the optical element, a mechanical strength of the optical element can be reinforced.

As an example of the bonded body obtained by bonding the laminate according to the embodiment of the present invention to the optical element, FIG. 2 shows a schematic cross-sectional view of an embodiment of the optical element-containing laminate according to the present invention.

In FIG. 2, an optical element-containing laminate 30 includes the above-described laminate 10, an optical element 32, and a second peelable protective layer 34. As described above, the laminate 10 includes the sticky adhesive layer 12, the optically isotropic layer 14, and the first peelable protective layer 16 from the optical element 32 side. In addition, the second peelable protective layer 34 includes a pressure-sensitive adhesive layer 36 and a support 38. In the second peelable protective layer 34, the pressure-sensitive adhesive layer 36 is disposed on the optical element 32 side with respect to the support 38.

In the optical element-containing laminate 30, even in a case where inspection light is incident from an oblique direction as indicated by a white arrow in FIG. 2, optical characteristics of the optical element 32 can be accurately inspected.

Hereinafter, members included in the optical element-containing laminate 30 will be described in detail.

The configuration of the laminate 10 in the optical element-containing laminate 30 is as described above.

### (Optical Element 32)

The type of the optical element is not particularly limited, and examples thereof include known optical elements.

Examples of the optical element include a diffraction element, a lens, and a prism. Among these, the optical element preferably includes an optically anisotropic layer which is formed of a liquid crystal compound and has a liquid crystal alignment pattern in which an orientation of an optical axis derived from the liquid crystal compound continuously rotates in at least one in-plane direction. Since the optically anisotropic layer having the above-described liquid crystal alignment pattern is thin and has low mechanical strength, it is preferable to bond the laminate according to the embodiment of the present invention to handle the optically anisotropic layer.

Hereinafter, the above-described optically anisotropic layer will be described in detail.

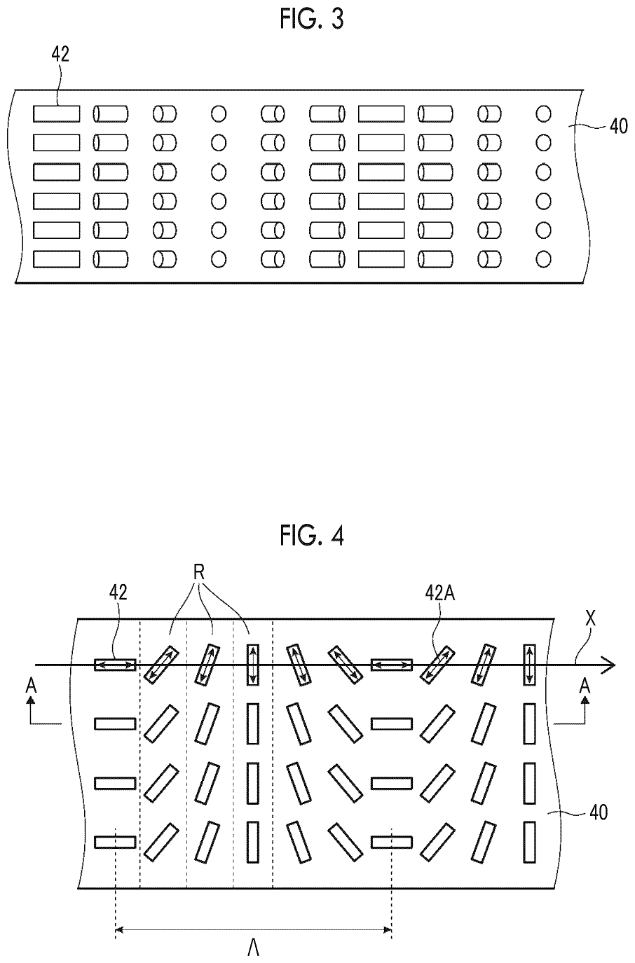

FIG. 3 is a side view conceptually showing an example of the optically anisotropic layer. FIG. 4 is a plan view of the optically anisotropic layer shown in FIG. 3. FIG. 3 is a cross-sectional view taken along line A-A in FIG. 4.

The plan view is a view in a case where the optically anisotropic layer 40 is seen from the top in FIG. 3, that is, FIG. 3 is a view in a case where the optically anisotropic layer 40 is seen from a thickness direction (laminating direction of the respective layers (films)). In other words, FIG. 4 is a view in a case where the optically anisotropic layer 40 is seen from a direction orthogonal to a main surface.

In FIG. 4, in order to clarify the configuration of the optically anisotropic layer 40, only the liquid crystal compound 42 on the surface side of the optically anisotropic layer 40 is shown. However, as shown in FIG. 3, the optically anisotropic layer 40 has a structure in which the liquid crystal compound 42 is laminated in the thickness direction.

As shown in FIG. 4, the optically anisotropic layer 40 has the liquid crystal alignment pattern in which the orientation of the optical axis 42A derived from the liquid crystal compound 42 changes while continuously rotating counterclockwise in the one direction indicated by an arrow X in a plane of the optically anisotropic layer 40. In FIG. 4, the orientation of the optical axis 42A derived from the liquid crystal compound 42 rotates counterclockwise. However, the present invention is not limited to this aspect, and the orientation of the optical axis 42A may rotate clockwise.

The optical axis 42A derived from the liquid crystal compound 42 is an axis having the highest refractive index in the liquid crystal compound 42. For example, in a case where the liquid crystal compound 42 is a rod-like liquid crystal compound, the optical axis 42A is along a major axis direction of the rod shape.

In the following description, the “one direction indicated by an arrow X” will also be simply referred to as “arrow X direction”. In addition, in the following description, the optical axis 42A derived from the liquid crystal compound 42 will also be referred to as “optical axis 42A of the liquid crystal compound 42” or “optical axis 42A”.

In the optically anisotropic layer 40, the liquid crystal compound 42 is two-dimensionally aligned in a plane parallel to the arrow X direction and a Y direction orthogonal to the arrow X direction. In FIG. 4, the Y direction is a direction perpendicular to the paper plane.

FIG. 4 conceptually shows a plan view of the optically anisotropic layer 40.

The optically anisotropic layer 40 has a liquid crystal alignment pattern in which an orientation of an optical axis 42A derived from the liquid crystal compound 42 changes while continuously rotating in the arrow X direction in a plane of the optically anisotropic layer 40.

Specifically, the “orientation of the optical axis 42A of the liquid crystal compound 42 changes while continuously rotating in the arrow X direction (predetermined one direction)” means that an angle between the optical axis 42A of the liquid crystal compound 42, which is arranged in the arrow X direction, and the arrow X direction varies depending on positions in the arrow X direction, and the angle between the optical axis 42A and the arrow X direction sequentially changes from θ to θ+180° or to θ−180° in the arrow X direction.

A difference between the angles of the optical axes 42A of the liquid crystal compounds 42 adjacent to each other in the arrow X direction is preferably 45° or less, more preferably 15° or less, and still more preferably less than 15°.

Meanwhile, regarding the liquid crystal compound 42 forming the optically anisotropic layer 40, the liquid crystal compounds 42 in which the orientations of the optical axes 42A are the same as one another are arranged at equal intervals in the Y direction orthogonal to the arrow X direction, that is, the Y direction orthogonal to one direction in which the optical axes 42A continuously rotate.

In other words, regarding the liquid crystal compound 42 forming the optically anisotropic layer 40, in the liquid crystal compounds 42 arranged in the Y direction, angles between the orientations of the optical axes 42A and the arrow X direction are the same.

In such a liquid crystal alignment pattern of the liquid crystal compound 42, the length (distance) over which the optical axis 42A of the liquid crystal compound 42 rotates by 180° in the arrow X direction that the orientation of the optical axis 42A continuously change while continuously rotating in a plane is defined by a length Λ of a single period in the liquid crystal alignment pattern. In other words, the length of the single period in the liquid crystal alignment pattern is defined as the distance between θ and θ+180° that is a range of the angle between the optical axis 42A of the liquid crystal compound 42 and the arrow X direction.

That is, in the arrow X direction, a distance between centers of two liquid crystal compounds 42 having the same angle with respect to the arrow X direction is set as the length A of the single period. Specifically, as shown in FIG. 4, the distance between the centers of two liquid crystal compounds 42 in which the arrow X direction and the direction of the optical axis 42A coincide with each other in the arrow X direction is set as the length Λ of the single period. In the description below, the length Λ of the single period is also referred to as “single period Λ”.

In the liquid crystal alignment pattern of the optically anisotropic layer 40, the single period A is repeated in the arrow X direction, that is, in the one direction along which the orientation of the optical axis 42A changes while continuously rotating.

As described above, in the optically anisotropic layer 40, the liquid crystal compounds 42 arranged in the Y direction have the same angle between the optical axis 42A and the arrow X direction (one direction in which the orientation of the optical axis of the liquid crystal compound 42 rotates). A region where the liquid crystal compounds 42 in which the angles between the optical axes 42A and the arrow X direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the optically anisotropic layer. Here, a difference in refractive index due to the refractive index anisotropy of the regions R in the optically anisotropic layer is defined by a difference between a refractive index of a direction of an in-plane slow axis of the region R and a refractive index of a direction orthogonal to the direction of the slow axis. That is, the difference in refractive index Δn due to the refractive index anisotropy of the regions R is the same as a difference between a refractive index of the liquid crystal compound 42 in the direction of the optical axis 42A and a refractive index of the liquid crystal compound 42 in a direction perpendicular to the optical axis 42A in a plane of the region R. That is, the above-described difference in refractive index Δn is the same as the difference in refractive index of the liquid crystal compound.

It is not necessary that the above-described 180° rotation period in the optically anisotropic layer is uniform over the entire surface. That is, the optically anisotropic layer may have regions having different lengths of the 180° rotation periods (lengths A of the single periods) in a plane.

The minimum value of the length of the single period over which the orientation of the optical axis derived from the liquid crystal compound rotates by 180° in a plane is preferably 20 μm or less, more preferably 5 μm or less, and still more preferably 2 μm or less. The lower limit thereof is not particularly limited, but is 0.5 μm or more in many cases.

In addition, the optically anisotropic layer may have a portion where the orientation of the optical axis is constant as long as a part thereof has the liquid crystal alignment pattern in which the orientation of the optical axis rotates in at least one in-plane direction.

The thickness of the optically anisotropic layer is not particularly limited, but is preferably ¼ times the minimum value of the length of the single period over which the orientation of the optical axis derived from the liquid crystal compound rotates by 180° in a plane. The upper limit thereof is not particularly limited, but is equal to or less than two times the above-described minimum value of the length of the single period in many cases.

The thickness of the optically anisotropic layer is not particularly limited, but is preferably 0.1 μm or more, more preferably 0.5 μm or more, and still more preferably 1.5 μm or more. The upper limit thereof is not particularly limited, and is preferably 20 μm or less and more preferably 15 or μm or less.

In the liquid crystal alignment pattern of the optically anisotropic layer 40 shown in FIGS. 3 and 4, the orientation of the optical axis 42A of the liquid crystal compound 42 continuously rotates only in the arrow X direction.

However, the present invention is not limited thereto, and various configurations can be used as long as the orientation of the optical axis of the liquid crystal compound in the optically anisotropic layer continuously rotates in one in-plane direction.

The liquid crystal compound used for forming the optically anisotropic layer can be generally classified into a rod-like type and a disk-like type, depending on the shape thereof. Furthermore, there are a low-molecular-weight type and a high-molecular-weight type for each of the rod-like type liquid crystal compound and the disk-like type liquid crystal compound. The term “high-molecular-weight” generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, but a rod-like liquid crystal compound or a disk-like liquid crystal compound is preferable.

A manufacturing method of the above-described optically anisotropic layer is not particularly limited, and a known method can be adopted. For example, a method using an alignment film described in JP2022-095795A can be used.

### (Second Peelable Protective Layer)

The optical element-containing laminate according to the embodiment of the present invention includes a second peelable protective layer. The second peelable protective layer is peeled off, and the exposed optical element can be bonded to an adherend.

An in-plane retardation Re4(550) of the second peelable protective layer at a wavelength of 550 nm and a thickness direction retardation Rth4(550) of the second peelable protective layer at a wavelength of 550 nm are not particularly limited, and it is preferable to satisfy a relationship of Expressions (4A) and (4B).

$$0 nm \leq Re 4 ( 550 ) \leq 10 nm \qquad Expression ( 4 A )$$

$$- 10 nm \leq Rth 4 ( 550 ) \leq 10 nm \qquad Expression ( 4 B )$$

Among these, the in-plane retardation Re4(550) of the second peelable protective layer at a wavelength of 550 nm preferably satisfies a relationship of Expression (4A-1).

$$0 nm \leq Re 4 ( 550 ) \leq 5 nm \qquad Expression ( 4 A - 1 )$$

In addition, the thickness direction retardation Rth4(550) of the second peelable protective layer at a wavelength of 550 nm preferably satisfies a relationship of Expression (4B-1).

$$- 8 nm \leq Rth 4 ( 550 ) \leq 8 nm \qquad Expression ( 4 B - 1 )$$

The configuration of the second peelable protective layer is not particularly limited as long as it is a member that exhibits the above-described optical characteristics and is peelable from the optical element, but it is preferable to include a support and a pressure-sensitive adhesive layer.

The definition and suitable aspect of the support in the second peelable protective layer are the same as the definition and suitable aspect of the support in the first peelable protective layer.

In addition, the definition and suitable aspect of the pressure-sensitive adhesive layer in the second peelable protective layer are the same as the definition and suitable aspect of the pressure-sensitive adhesive layer in the first peelable protective layer.

As described above, since the optical element-containing laminate includes the optically isotropic layer, the first peelable protective layer, and the second peelable protective layer, damage to the optical element is suppressed, and the handleability is also improved.

In a case where the optical element in the optical element-containing laminate is bonded to a member, for example, the optical element, the sticky adhesive layer, and the optically isotropic layer can be transferred onto the member by peeling off the second peelable protective layer, bonding the exposed optical element to the member through a pressure sensitive adhesive, and peeling off the first peelable protective layer.

### EXAMPLES

Hereinafter, the present invention will be described in more detail with reference to Examples. The materials, amounts used, proportions, treatment details, treatment procedure, and the like shown in the following Examples can be appropriately changed without departing from the spirit and scope of the present invention. Therefore, the scope of the present invention should not be construed as being limited to Examples shown below.

### Example 1

A coating liquid was prepared by adding a predetermined amount of a curing agent to a re-peelable type acrylic pressure sensitive adhesive A obtained by diluting an acrylic pressure sensitive adhesive with ethyl acetate and toluene. The amount of the curing agent used was adjusted to appropriately adjust an adhesive strength between the optically isotropic layer and the first peelable protective layer.

The produced coating liquid was applied onto a peeling-treated polyethylene terephthalate film so that a dry film thickness was a value of the film thickness in Table 1, thereby forming a pressure-sensitive adhesive layer.

Thereafter, the pressure-sensitive adhesive layer formed on the peeling-treated polyethylene terephthalate film was bonded to a low retardation triacetyl cellulose (TAC) film (trade name: ZRG40) having a thickness of 40 μm. Thereafter, the obtained laminate was aged for 7 days in an environment of 23° C. and a humidity of 65% to obtain a laminate including the TAC film, the pressure-sensitive adhesive layer, and the peeling-treated polyethylene terephthalate film.

Next, a first peelable protective layer including a TAC film obtained by peeling the peeling-treated polyester film from the laminate produced above and a pressure-sensitive adhesive layer was bonded to one surface of a low retardation TAC film (trade name: ZRG20) having a thickness of 20 μm, which was an optically isotropic layer. During the bonding, the bonding was performed such that the pressure-sensitive adhesive layer of the first peelable protective layer faced the optically isotropic layer.

Next, a pressure-sensitive adhesive layer (corresponding to the sticky adhesive layer) having a thickness of 15 μm was bonded to a surface of the low retardation TAC film, which was an optically isotropic layer, to which the first peelable protective layer was not bonded, using an optical pressure sensitive adhesive film (manufactured by LINTEC Corporation: NCF-D692), thereby producing a laminate 1.

### Examples 2 to 8 and Comparative Examples 1 to 5

Laminates 2 to 8 and laminates C1 to C5 were produced according to the same procedure as in Example 1, except that the types of the first peelable protective layer, the optically isotropic layer, and the sticky adhesive layer were changed so that various characteristics as shown in Table 1 were obtained.

### <Evaluation>

An optically anisotropic layer having a liquid crystal alignment pattern was produced on a glass substrate according to a method described in Example 1 of WO2022/050319A.

Next, the sticky adhesive layer side in the laminate produced in Examples and Comparative Examples was bonded to the above-described optically anisotropic layer, and then the optically anisotropic layer was peeled off from the glass substrate to transfer the optically anisotropic layer to the laminate. That is, a bonded body including the optically anisotropic layer and the laminate of Examples and Comparative Examples was obtained.

Next, the pressure-sensitive adhesive layer side of the first peelable protective layer produced in each of Examples and Comparative Examples was bonded to the exposed peeling surface of the optically anisotropic layer to obtain a sample for evaluation of each of Examples and Comparative Examples (corresponding to the optical element-containing laminate described above).

### (Light Leakage Measurement (Evaluation of Detection Accuracy))

An evaluation device was assembled such that dextrorotatory circularly polarized light having a wavelength of 532 nm collimated by the optically anisotropic layer having the liquid crystal alignment pattern used in the production of the sample for evaluation described above was incident at an incidence angle of 30° (angle with respect to a normal direction of a surface of the optically anisotropic layer) and emitted without being diffracted, and the light was incident perpendicularly to the detector through a levorotatory circularly polarizing plate (polarizing plate which transmitted levorotatory circularly polarized light). A proportion (%) of the intensity of the light emitted without being diffracted to the intensity of the incidence light {(Intensity of light emitted without being diffracted/Intensity of incidence light)×100} was measured.

Next, the sample for evaluation of each of Examples and Comparative Examples was provided instead of the above-described optically anisotropic layer, and the same evaluation as described above was performed. The sample for evaluation was installed such that the incidence light was incident from the side of the laminate (laminates 1 to 8 and C1 to C6) in each sample for evaluation.

A difference between the proportion of the intensity obtained by using the above-described optically anisotropic layer and the proportion of the intensity obtained by using the sample for evaluation was compared; and as the difference was smaller, the optical characteristics of the optically anisotropic layer could be inspected more accurately even in a case where the laminate was disposed on the optically anisotropic layer.

The evaluation was performed according to the following standard.

A: difference between the proportion of the intensity obtained by using the optically anisotropic layer and the proportion of the intensity obtained by using the sample for evaluation was within 0.2%.

B: difference between the proportion of the intensity obtained by using the optically anisotropic layer and the proportion of the intensity obtained by using the sample for evaluation was more than 0.2% and 0.4% or less.

C: difference between the proportion of the intensity obtained by using the optically anisotropic layer and the proportion of the intensity obtained by using the sample for evaluation was more than 0.4%.

### (Evaluation of Adhesiveness)

After bonding the laminate of each of Examples and Comparative Examples to Eagle XG glass on the sticky adhesive layer side, the first peelable protective layer was peeled off. In a case where the first peelable protective layer was peeled off, floating or peeling between the optically isotropic layer and the sticky adhesive layer was evaluated according to the following standard.

A: no floating or peeling occurred between the optically isotropic layer and the sticky adhesive layer.

B: floating occurred between the optically isotropic layer and the sticky adhesive layer.

C: peeling occurred between the optically isotropic layer and the sticky adhesive layer.

In the table, the column of “Adhesive strength to optically isotropic layer (N/25 mm)” in the column of “Pressure-sensitive adhesive layer” indicates an adhesive strength between the optically anisotropic layer and the first peelable protective layer (pressure-sensitive adhesive layer).

In the table, the column of “Re(550) (nm)” in the column of “First peelable protective layer” indicates an in-plane retardation (nm) of the first peelable protective layer at a wavelength of 550 nm. The in-plane retardation of the support in the first peelable protective layer in each of Examples and Comparative Examples at a wavelength of 550 nm was also the same value as the value shown in the column of “Re(550) (nm)” in the column of “First peelable protective layer” of each of Examples and Comparative Examples.

In the table, the column of “Rth(550) (nm)” in the column of “First peelable protective layer” indicates a thickness direction retardation (nm) of the first peelable protective layer at a wavelength of 550 nm. The thickness direction retardation of the support in the first peelable protective layer in each of Examples and Comparative Examples at a wavelength of 550 nm was also the same value as the value shown in the column of “Rth(550) (nm)” in the column of “First peelable protective layer” of each of Examples and Comparative Examples.

In the table, the column “Re(550) (nm)” in the column “Optically isotropic layer” indicates an in-plane retardation (nm) of the optically isotropic layer at a wavelength of 550 nm.

In the table, the column of “Rth(550) (nm)” in the column of “Optically isotropic layer” indicates a thickness direction retardation (nm) of the optically isotropic layer at a wavelength of 550 nm.

In the table, the column of “Adhesive strength to optically isotropic layer (N/25 mm)” in the column of “Sticky adhesive layer” indicates an adhesive strength between the optically anisotropic layer and the sticky adhesive layer.

In the table, abbreviations in the column of “Type” in the column of “Support” are as follows.

“TAC”: triacetyl cellulose film (ZRG40)

“PET”: polyethylene terephthalate film (LUMIRROR manufactured by Toray Industries, Inc.)

In the table, abbreviations in the column of “Type” in the column of “Optically isotropic layer” are as follows.

“TAC”: triacetyl cellulose film (ZRG20)

“COP”: cycloolefin polymer film (ARTON film (trade name) manufactured by JSR Corporation)

“Acrylic”: acrylic polymer film (OXIS-PMMA (trade name) manufactured by OKURA INDUSTRIAL CO., LTD.)

“PC”: polycarbonate film (PURE-ACE manufactured by Teijin Limited)

TABLE 1

| | First peelable protective layer | | | | | | | | | Sticky | | |
|---|---|---|---|---|---|---|---|---|---|---|---|---|
| | | Pressure-sensitive | | | | | | | | adhesive | | |
| | | adhesive layer | | | | | | | | layer | | |
| | | | Adhesive | | | | | | | Adhesive | | |
| | | | strength to | | | Optically isotropic layer | | | | strength to | Evaluation | |
| | | Film | optically | | | | Film | | | optically | Light | |
| | | thick- | isotropic | | | | thick- | | | isotropic | leakage | Evaluation |
| | Support | ness | layer | Re(550) | Rth(550) | | ness | Re(550) | Rth(550) | layer | measure- | of adhe- |
| | Type | (μm) | (N/25 mm) | (nm) | (nm) | Type | (μm) | (nm) | (nm) | (N/25 mm) | ment | siveness |
| Example 1 | TAC | 10 | 0.2 | 0 | 6 | TAC | 20 | 0 | 3 | 15.0 | A | A |
| Example 2 | TAC | 10 | 0.1 | 0 | 6 | COP | 25 | 2 | 4 | 2.0 | A | A |
| Example 3 | TAC | 10 | 0.4 | 0 | 6 | Acrylic | 40 | 4 | −10 | 2.0 | B | A |
| Example 4 | TAC | 15 | 0.5 | 0 | 6 | PC | 50 | 2 | 10 | 2.0 | B | A |
| Example 5 | TAC | 10 | 0.2 | 0 | 6 | TAC | 20 | 0 | 3 | 10.0 | A | A |
| Example 6 | TAC | 20 | 1.0 | 0 | 6 | TAC | 20 | 0 | 3 | 2.0 | A | A |
| Example 7 | TAC | 20 | 1.0 | 0 | 6 | TAC | 20 | 0 | 3 | 1.0 | A | B |
| Example 8 | TAC | 20 | 1.0 | 0 | 6 | PC | 50 | 2 | 10 | 0.5 | B | C |
| Comparative | PET | 10 | 0.2 | 200 | 200 | TAC | 20 | 0 | 3 | 2.0 | C | A |
| Example 1 | | | | | | | | | | | | |
| Comparative | TAC | 10 | 0.2 | 0 | 40 | TAC | 20 | 0 | 3 | 2.0 | C | A |
| Example 2 | | | | | | | | | | | | |
| Comparative | TAC | 10 | 0.2 | 20 | 10 | TAC | 20 | 0 | 3 | 2.0 | C | A |
| Example 3 | | | | | | | | | | | | |
| Comparative | TAC | 10 | 0.2 | 0 | 6 | TAC | 20 | 0 | 40 | 2.0 | C | A |
| Example 4 | | | | | | | | | | | | |
| Comparative | TAC | 10 | 0.2 | 0 | 6 | TAC | 20 | 20 | 10 | 2.0 | C | A |
| Example 5 | | | | | | | | | | | | |

As shown in the table, it was found that a desired effect was obtained in a case where the laminate according to the embodiment of the present invention was used.

From the comparison between Examples 7 and 8 and other Examples, it was found that, in a case where the adhesive strength between the first peelable protective layer and the optically isotropic layer was smaller than the adhesive strength between the optically isotropic layer and the sticky adhesive layer (or in a case where the adhesive strength between the optically isotropic layer and the sticky adhesive layer was 1.0 N/25 mm or more), the evaluation of the adhesiveness was more excellent.

### EXPLANATION OF REFERENCES

10: laminate
12: sticky adhesive layer
14: optically isotropic layer
16: first peelable protective layer
18, 36: pressure-sensitive adhesive layer
20, 38: support
30: optical element-containing laminate
32: optical element
34: second peelable protective layer
40: optically anisotropic layer
42: liquid crystal compound

What is claimed is:

1. A laminate comprising, in the following order:
a sticky adhesive layer;
an optically isotropic layer; and
a first peelable protective layer,
wherein an in-plane retardation Re1(550) of the optically isotropic layer at a wavelength of 550 nm and a thickness direction retardation Rth1(550) of the optically isotropic layer at a wavelength of 550 nm satisfy a relationship of the following expressions (1A) and (1B), and
an in-plane retardation Re2(550) of the first peelable protective layer at a wavelength of 550 nm and a thickness direction retardation Rth2(550) of the first peelable protective layer at a wavelength of 550 nm satisfy a relationship of the following expressions (2A) and (2B),
$$0 nm \leq Re 1 ( 550 ) \leq 10 nm , \qquad expression ( 1 A )$$
$$- 10 nm \leq Rth 1 ( 550 ) \leq 10 nm , \qquad expression ( 1 B )$$
$$0 nm \leq Re 2 ( 550 ) \leq 10 nm , \qquad expression ( 2 A )$$
$$- 10 nm \leq Rth 2 ( 550 ) \leq 10 nm . \qquad expression ( 2 B )$$

2. The laminate according to claim 1,
wherein an adhesive strength between the first peelable protective layer and the optically isotropic layer is smaller than an adhesive strength between the optically isotropic layer and the sticky adhesive layer.

3. The laminate according to claim 1,
wherein an adhesive strength between the optically isotropic layer and the sticky adhesive layer is 1.0 N/25 mm or more.

4. The laminate according to claim 1,
wherein the first peelable protective layer includes a support and a pressure-sensitive adhesive layer,
the pressure-sensitive adhesive layer is disposed on an optically isotropic layer side with respect to the support, and
an in-plane retardation Re3(550) of the support at a wavelength of 550 nm and a thickness direction retardation Rth3(550) of the support at a wavelength of 550 nm satisfy a relationship of the following expressions (3A) and (3B),
$$0 nm \leq Re 3 ( 550 ) \leq 10 nm , \qquad expression ( 3 A )$$
$$- 10 nm \leq Rth 3 ( 550 ) \leq 10 nm . \qquad expression ( 3 B )$$

5. The laminate according to claim 1,
wherein the optically isotropic layer contains at least one selected from the group consisting of a triacetyl cellulose, an acrylic polymer, a methacrylic polymer, a cycloolefin polymer, and a polycarbonate.

6. The laminate according to claim 4,
wherein a thickness of the pressure-sensitive adhesive layer is 5 to 30 μm.

7. The laminate according to claim 1,
wherein a thickness of the optically isotropic layer is 5 to 60 μm.

8. An optical element-containing laminate comprising, in the following order:
the laminate according to claim 1;
an optical element; and
a second peelable protective layer,
wherein the sticky adhesive layer in the laminate is disposed on an optical element side with respect to the first peelable protective layer, and
an in-plane retardation Re4(550) of the second peelable protective layer at a wavelength of 550 nm and a thickness direction retardation Rth4(550) of the second peelable protective layer at a wavelength of 550 nm satisfy a relationship of the following expressions (4A) and (4B),
$$0 nm \leq Re 4 ( 550 ) \leq 10 nm , \qquad expression ( 4 A )$$
$$- 10 nm \leq Rth 4 ( 550 ) \leq 10 nm . \qquad expression ( 4 B )$$

9. The laminate according to claim 2,
wherein the first peelable protective layer includes a support and a pressure-sensitive adhesive layer,
the pressure-sensitive adhesive layer is disposed on an optically isotropic layer side with respect to the support, and
an in-plane retardation Re3(550) of the support at a wavelength of 550 nm and a thickness direction retardation Rth3(550) of the support at a wavelength of 550 nm satisfy a relationship of the following expressions (3A) and (3B),
$$0 nm \leq Re 3 ( 550 ) \leq 10 nm , \qquad expression ( 3 A )$$
$$- 10 nm \leq Rth 3 ( 550 ) \leq 10 nm . \qquad expression ( 3 B )$$

10. The laminate according to claim 2,
wherein the optically isotropic layer contains at least one selected from the group consisting of a triacetyl cellulose, an acrylic polymer, a methacrylic polymer, a cycloolefin polymer, and a polycarbonate.

11. The laminate according to claim 5,
wherein a thickness of the pressure-sensitive adhesive layer is 5 to 30 μm.

12. The laminate according to claim 2,
wherein a thickness of the optically isotropic layer is 5 to 60 μm.

13. An optical element-containing laminate comprising, in the following order:
the laminate according to claim 2;
an optical element; and
a second peelable protective layer,
wherein the sticky adhesive layer in the laminate is disposed on an optical element side with respect to the first peelable protective layer, and
an in-plane retardation Re4(550) of the second peelable protective layer at a wavelength of 550 nm and a thickness direction retardation Rth4(550) of the second peelable protective layer at a wavelength of 550 nm satisfy a relationship of the following expressions (4A) and (4B),
$$0 nm \leq Re 4 ( 550 ) \leq 10 nm , \qquad expression ( 4 A )$$
$$- 10 nm \leq Rth 4 ( 550 ) \leq 10 nm . \qquad expression ( 4 B )$$

14. The laminate according to claim 3,
wherein the first peelable protective layer includes a support and a pressure-sensitive adhesive layer,
the pressure-sensitive adhesive layer is disposed on an optically isotropic layer side with respect to the support, and
an in-plane retardation Re3(550) of the support at a wavelength of 550 nm and a thickness direction retardation Rth3(550) of the support at a wavelength of 550 nm satisfy a relationship of the following expressions (3A) and (3B),
$$0 nm \leq Re 3 ( 550 ) \leq 10 nm , \qquad expression ( 3 A )$$
$$- 10 nm \leq Rth 3 ( 550 ) \leq 10 nm . \qquad expression ( 3 B )$$

15. The laminate according to claim 3,
wherein the optically isotropic layer contains at least one selected from the group consisting of a triacetyl cellulose, an acrylic polymer, a methacrylic polymer, a cycloolefin polymer, and a polycarbonate.

16. The laminate according to claim 15,
wherein a thickness of the pressure-sensitive adhesive layer is 5 to 30 μm.

17. The laminate according to claim 3,
wherein a thickness of the optically isotropic layer is 5 to 60 μm.

18. An optical element-containing laminate comprising, in the following order:
the laminate according to claim 3;
an optical element; and
a second peelable protective layer,
wherein the sticky adhesive layer in the laminate is disposed on an optical element side with respect to the first peelable protective layer, and
an in-plane retardation Re4(550) of the second peelable protective layer at a wavelength of 550 nm and a thickness direction retardation Rth4(550) of the second peelable protective layer at a wavelength of 550 nm satisfy a relationship of the following expressions (4A) and (4B),
$$0 nm \leq Re 4 ( 550 ) \leq 10 nm , \qquad expression ( 4 A )$$
$$- 10 nm \leq Rth 4 ( 550 ) \leq 10 nm . \qquad expression ( 4 B )$$

19. The laminate according to claim 4,
wherein the optically isotropic layer contains at least one selected from the group consisting of a triacetyl cellulose, an acrylic polymer, a methacrylic polymer, a cycloolefin polymer, and a polycarbonate.

20. The laminate according to claim 19,
wherein a thickness of the pressure-sensitive adhesive layer is 5 to 30 μm.
